(19) United States
(12) Patent Application Publication
(10) Pub. No.: US 2007/0150701 A1
(43) Pub. Date: Jun. 28, 2007

(54) Method and arrangement for power-efficient control of processors

(76) Inventors: Uwe Porst, Dresden (DE); Wolfram Drescher, Dresden (DE)

Correspondence Address: BAKER BOTTS L.L.P., 30 ROCKEFELLER PLAZA, 44TH FLOOR, NEW YORK, NY, 10112-4498, US

(21) Appl. No.: 10/511,575

(22) PCT Filed: May 13, 2003
(86) PCT No.: PCT/DE03/01540

§ 371 Date: Apr. 11, 2005

(30) Foreign Application Priority Data
May 14, 2002 (DE) 102 21 530.8

(51) Int. Cl. G06F 15/00

(52) U.S. Cl. 712/24

(57) ABSTRACT

A method is provided for the functional control of program and/or data flows in digital signal processors and processors, which have respective closed and separated modules for program and data flow control, working in parallel with computers. The method enables a power-efficient adaptation of the signal processing with the applied SIMD command-type in the individual paths and minimizes the emergence of the appearance of NOP-commands with which the VLIW-architecture of the processor must be supplied. The adaptation of the signal processing is achieved by individually controlling the parallel signal processing of the processor in the data paths (DP) which respectively belong to a first and second slice. For this purpose, a single slice halt outputted from an SSM register bank switches the register clockline according to state-dependent signal processing.

### CROSS REFERENCE TO RELATED APPLICATIONS

This application claims the benefit of International Patent Application No. PCT/DE03/01540 filed May 13, 2003, which claims priority to German Patent Application No. 010221530.8 filed May 14, 2002.

### FIELD OF THE INVENTION

The invention relates to methods for functionally controlling program and/or data flow in digital signal processors and processors. In particular, the invention relates to parallel processing in processors having respective closed modules that are separate from one another, are intended for program and data flow control, and operate in parallel arithmetic units.

### BACKGROUND OF THE INVENTION

Processors whose architecture has a slice structure are gaining increasing importance in digital signal processors (DSP). In this case, data paths are combined to form slices, a signal processing operation in a first slice being carried out independently of the signal processing that is taking place in a parallel manner in a second slice.

If operations are carried out in the parallel arithmetic units of these digital signal processors using Single Instruction, Multiple Data. (SIMD) instruction type, the problem arises in the prior art that the algorithms used in this case are often not suited to the parallel signal processing in all of the slices.

In the case of the signal processing in the individual slices, for example, the results obtained can therefore usually be provided only at different points in time or after a different number of processor clock cycles in the respective slice as a result of the respective different algorithms used there.

The system of processing instructions in a manner that concurs with the other SIMD slices either cannot be implemented at all or can be implemented only with a high outlay.

This necessarily high outlay occurs, on the one hand, in terms of software, as additional programs which are to be executed and organize the different waiting times for the slices in order to provide the results in a parallel manner.

This high outlay arises, on the other hand, in the hardware, as heavy processor and memory utilization that reduces the processor performance. This reduction may be averted, for example, by expanding the memory but this signifies an increase in the outlay on hardware.

It proves to be disadvantageous in the prior art that, in order to necessarily adapt the algorithms to the SIMD instruction type during the signal processing, primarily in the slices with their associated data paths, these slices and the additional associated Very Long Instruction Word (VLIW) architecture of the processor have to be supplied, to a considerable extent, with No Operation instructions (NOPs).

This not only renders the power-increasing effects of using the SIMD instruction type ineffective but also requires an additional outlay on hardware and software in order to adapt the algorithms.

Consideration is now being given to ways of enhancing or improving signal processing methods for parallel processing.

### SUMMARY OF THE INVENTION

In accordance with the principles of the invention, a method is provided for improving signal processing in a parallel processor. The method individually adapts the signal processing in the individual data paths when the SIMD instruction type is used. The signal processing in the individual data paths is adapted in a power-efficient manner and, in particular, to minimize the occurrence of NOP instructions with which the VLIW architecture of the processor must be supplied.

A preferred method for functionally controlling the program and/or data flow may be implemented in signal processors, which have closed modules that are separate from one another, are intended for program and data flow control, and operate in parallel arithmetic units, The method involves controlling signal processing in the processors individually in data paths (DP) that are respectively associated with a first and a second slice, as a result of the SIMD instructions which are converted by a Process Controlling Unit (PCU) of the signal processors. A Single Slice Mode (SSM) register bank outputs a single slice halt state. The single slice halt state is used as a controlling state according to bits, which are assigned to each slice, to switch a register clock supply via respective first and second gated clock cells. As a result, the functioning of the assigned input register and/or accumulator and/or pipeline control register is stopped in the meantime depending on the state of the signal processing occurring in the DP associated with the respective slice. The functions of these registers or accumulator is re-enabled only when the single slice halt state that has been output is discontinued as a result of another or next SIMD instruction. During this processor activity, a register file unit (RFU) and a memory access register of the processor remain in operation irrespective of the single slice halt state output by the SSM register bank. Accordingly, the PCU can write to the SSM register bank of the PCU at any time.

In another aspect, the method may involve controlling the clock supply for a VLIW unit of the processors by means of a software-dictated output of the state from the program flow of the processors, in such a manner that, as a result, partial instruction words which are currently present in the VLIW unit are subsequently provided in the latter for multiple use at the functional units of the processors. The generation of further VLIWs in the VLIW unit may be interrupted by a PCU of the processors, which is being informed of a VLIW WAIT command via an advance signal line. The VLIW WAIT command is applied to the PCU in the next clock cycle. The PCU response, switches the clock supply for the VLIW unit by means of a VLIW WAIT signal line and a third gated clock cell of the processors.

### BRIEF DESCRIPTION OF THE DRAWINGS

Further features of the invention, its nature, and various advantages will be more apparent from the following detailed description and the accompanying drawings, wherein like reference characters represent like elements t throughout, and in which:

FIG. 1 is a block diagram of an exemplary processor with associated functional units that can be used to implement the methods for individually adapting signal processing, in accordance with the principles of the present invention.

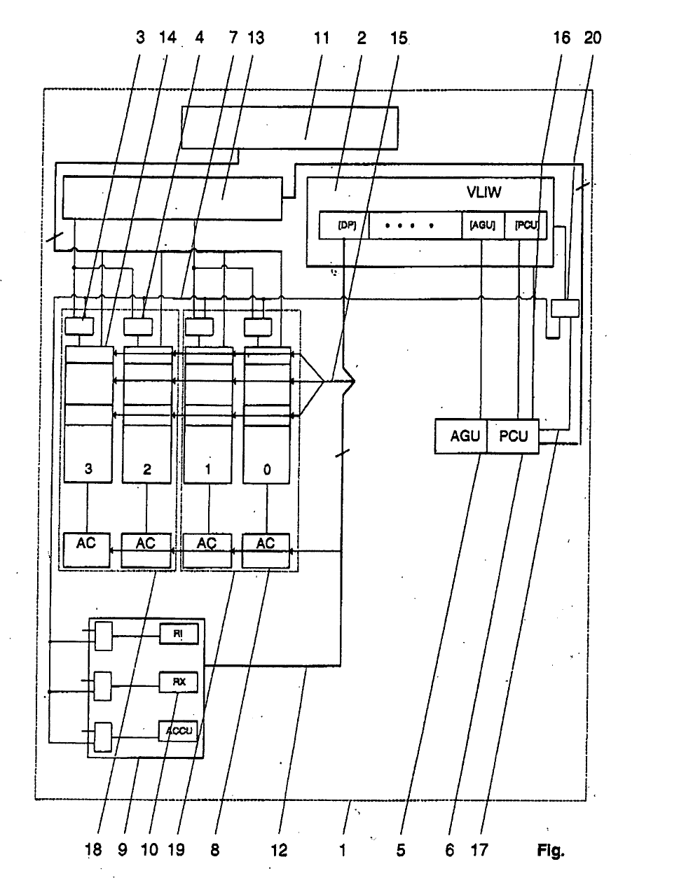

The following is a list of reference symbols used in FIG. 1

### List Of Reference Symbols

1 Processor

2 VLIW (Very Long Instruction Word) unit

3 First gated clock cell

4 Second gated clock cell

5 AGU (Address Generating Unit)

6 PCU (Process Controlling Unit)

7 Clock supply line

8 Accumulator

9 Further processing unit (with gated clock cell)

10 Register of the further processing unit

11 RFU (Register File Unit)

12 SIMD control bus

13 SSM (Single Slice Mode) register bank

14 Datapath

15 SIMD data path control line

16 Advance signal line

17 VLIW WAIT signal line

18 First slice

19 Second slice

20 Third gated clock cell

### DETAILED DESCRIPTION OF THE INVENTION

The present invention provides a method for parallel processing. The method involves individually adapting the signal processing in a processor when the SIMD instruction type is used. The signal processing is adapted in the individual data paths in a power-efficient manner and, in particular, to minimize the occurrence of NOP instructions with which the VLIW architecture of the processor must be supplied.

This object is achieved according to the invention by means of the fact that the parallel signal processing—as a result of the SIMD instructions which are converted by the Process Controlling Unit (PCU)—of the processor is individually controlled, in a respective data path (DP) of a first and a second slice, by means of a “single slice halt” state that is output by an Single Slice Mode (SSM) register bank for each slice.

In this case, the controlling effect of the “single slice halt” state that has been output is achieved by the bits (which are assigned to the first and second slices) of the SSM register bank switching the register clock supply via the respectively associated first and second gated clock cells.

As a result, the associated input register and/or accumulator and/or pipeline control register is/are stopped in the meantime depending on the state of the signal processing occurring in the slice of the data path.

This functioning is enabled only by the “single slice halt” state that has been output being discontinued when a further SIMD instruction is converted.

The register file unit (RFU) and the memory access register of the processor remain in operation irrespective of the “single slice halt” state that has been output. The PCU can in this case write to the SSM register bank of the PCU at any time.

This solution is aimed at beginning with the individual calculations in a parallel manner in the slices of the data paths of the processor, in accordance with the SIMD instruction type.

However, as a result of the different calculation processes, the intermediate and/or final results in the slices are provided at different points in time in the pipeline control registers, accumulators and result registers of the associated data paths.

After the intermediate and/or final result values have been provided, a further signal processing operation that is no longer laden with results is thus prevented in the data paths which are associated with the individual slices.

The signal processing is continued in a parallel manner in all of the data paths of the slices if a start is made on processing a further SIMD instruction.

A supplementary embodiment of the solution, according to the invention, of the formulated object consists in controlling the clock supply for the VLIW unit, by means of a software-dictated output of the state from the program flow of the processor, in such a manner that, as a result, partial instruction words which are currently present in the VLIW unit are subsequently provided in the latter for multiple use at the functional units.

This solution according to the invention advantageously becomes effective if necessary adaptation of the algorithms to the SIMD instruction type during the signal processing makes it necessary for the data paths and the associated VLIW architecture of the processor to be supplied with No Operation instructions (NOPs) or similar instructions with a high repetition rate. In this case, avoiding the generation of identical VLIWs reduces the amount of memory space used and keeps the computing load of the processor low, with the result that the computing power is efficiently available for the important calculations.

One advantageous variant of the supplementary embodiment of the solution according to the invention consists in interrupting the generation of further VLIWs in the VLIW unit by the PCU being informed of a VLIW WAIT command via an advance signal line and this command being applied to the PCU in the next clock cycle, the PCU then switching the clock supply for the VLIW unit by means of a “VLIW WAIT” signal line and a third gated clock cell.

This solution is aimed at being able to realize debugging routines in software tests by it being possible to set and start software breakpoints in the program code.

The invention will be explained in more detail below with reference to an exemplary embodiment for outputting a single slice halt state. The figure of the drawing contains a block diagram of the processor, in which the parts with the associated functional units which relate to the solution according to the invention are given.

In the event of the “single slice halt” state being output, it is a prerequisite that an SIMD instruction is output by the VLIW unit 2 via the SIMD control bus 12. This individual SIMD instruction triggers multiple data processing in the respective data path 14 of the first and second slices 18 and 19.

The results are provided at different points in time in the associated accumulator 8. In this case, a respective bit (which is assigned to the first and second slices 18 and 19) of the SSM register bank 13 is set.

The signal allocation of this bit is supplied, via the first and/or second gated clock cell 3 and 4, to the data path 14 (that is respectively associated with the first and second slices 18 and 19) and individually controls the signal processing in the first and second slices 18 and 19 in that the clock supply at the associated input register and thus also the signal processing are prevented when a result is present in this slice.

When a further SIMD instruction is output on the SIMD control bus 12, for example, after the last result worked out in one of the slices has been provided, the respective bit of the SSM register bank 13 is reset and all of the data paths begin the next signal processing operation by reading in the data provided by the Register File Unit (RFU) 11 at their input registers.

The signal processing in the individual slices of the data paths 14 is thus advantageously adapted to the requirements of parallel processing of the SIMD instructions.

What is claimed is:

1. A method for functionally controlling the program and/or data flow in signal processors, wherein the signal processors have respective closed modules that are separate from one another, are intended for program and data flow control, and operate in parallel arithmetic units, the method comprising:
as a result of the SIMD instructions which are converted by a Process Controlling Unit (PCU) of the signal processors, controlling parallel signal processing in the processors individually in data paths (DP) that are respectively associated with a first and a second slice;
by means of a single slice halt state that is output by a Single Slice Mode (SSM) register bank, the controlling effect of the “single slice halt” state that has been output being achieved by the bits, which are assigned to each slice, of the SSM register bank, switching the register clock supply via respective first and second gated clock cells;
as a result, stopping the functioning of the assigned input register and/or accumulator and/or pipeline control register in the meantime depending on the state of the signal processing occurring in the DP associated with the respective slice; and
enabling said functioning again only when the single slice halt state that has been output is discontinued as a result of a further SIMD instruction being converted,
wherein a register file unit (RFU) and a memory access register of the processors remain in operation irrespective of the single slice halt state that has been output and the PCU can in this case write to the SSM register bank of the PCU at any time.

2. A method for functionally controlling the program and/or data flow in digital signal processors and processors, wherein the processors have respective closed modules that are separate from one another, are intended for program and data flow control, and operate in parallel arithmetic units, the method comprising:
controlling the clock supply for a VLIW unit of the processors by means of a software-dictated output of the state from the program flow of the processors, in such a manner that, as a result, partial instruction words which are currently present in the VLIW unit are subsequently provided in the latter for multiple use at the functional units of the processors.

3. The method as claimed in claim 2, wherein the generation of further VLIWs in the VLIW unit is interrupted by a PCU of the processors being informed of a VLIW WAIT command via an advance signal line and wherein this command is applied to the PCU in the next clock cycle, the PCU then switching the clock supply for the VLIW unit by means of a VLIW WAIT signal line and a third gated clock cell of the processors.
